(19) United States
(12) Patent Application Publication
(10) Pub. No.: US 2009/0008901 A1
(43) Pub. Date: Jan. 8, 2009

(54) WHEELCHAIR LEVER HANDLES

(76) Inventors: Bette McCombs Guzman, Pleasant Hill, IA (US); Troy A. Johnson, Newton, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/772,576

(22) Filed: Jul. 2, 2007

(51) Int. Cl. A61G 5/10; A61G 5/00

(52) U.S. Cl. 280/304.1; 16/111.1; 16/430

(57) ABSTRACT

Improved handles are provided for a wheelchair brake lever and legrest release lever of a wheelchair. Each handle has a first end with a slot for receiving the respective lever, and a second end extending angularly from the first end so as to be nonplanar and noncoaxial with the respective levers. The handles include ribs or textured surfaces for improved tactile feel, and are made of brightly colored material for high visibility. Increased size, feel and visibility of the handles make them easier to locate for a person sitting in the wheelchair.

### BACKGROUND OF THE INVENTION

Most standard and custom fit wheelchairs typically have brakes for the wheels which include a lever and a linkage for locking and unlocking the brakes. The lever is a small metal plate, which typically is covered with a small plastic or rubber handle which is mounted on the lever, and essentially, provides a covering for the metal lever. This small cap or handle is not ergonomically designed, and thus is difficult for some patients to locate while seated in the wheelchair. The small size of the handle can be difficult to feel, particularly for patients with loss of feelings in their hands, and its dark color makes it difficult to see for most patients, especially those with visual impairments.

Wheelchairs often have front legrests with a foot plate to support a patient's feet slightly above the ground, for ease in rolling the wheelchair from one location to another. The legrest assemblies are removable when their use is not desired or unnecessary. A legrest release lever is provided to latch and unlatch the legrest assembly to the wheelchair frame. In some prior art wheelchairs, the release lever includes a small rubber or plastic cap or handle. This release lever is located below the level of the wheelchair seat, and thus is often difficult to locate for a person sitting in the wheelchair. The legrest release lever handle is usually small and of a dark color, with no tactile or visual enhancement to assist in the location of the lever.

Therefore, a primary objective of the present invention is the provision of improved handles for the actuation levers of a wheelchair.

A further objective of the present invention is the provision of a wheelchair brake handle which is easy to locate by sight and/or touch.

Another objective of the present invention is the provision of a legrest release lever handle which is easy to locate by sight and/or touch.

A further objective of the present invention is the provision of handles for the wheelchair brake lever and for the legrest release lever which have enhanced tactile feel.

A further objective of the present invention is the provision of handles for the wheelchair brake lever and for the legrest release lever which have enhanced visual characteristics.

Still another objective of the present invention is the provision of handles for the wheelchair brake lever and for the legrest release lever which are ergonomically designed for improved user actuation.

Yet another objective of the present invention is the provision of handles for the wheelchair brake levers which are symmetric so as to be used on both sides of the wheelchair.

Yet another objective of the present invention is the provision of handles for the legrest release levers which are symmetric so as to be used on both sides of the wheelchair.

A further objective of the present invention is the provision of improved handles for the wheelchair brake levers and legrest release levers which are textured so as to allow tactile differentiation from other parts or components of the wheelchair.

A further objective of the present invention is the provision of improved handles which fit on wheelchair brake levers of various wheelchair models.

A further objective of the present invention is the provision of improved handles which fit on the legrest release levers of various wheelchair models.

Still another objective of the present invention is the provision of improved wheelchair handles, for use on the various wheelchair levers, which are economical to manufacture, and durable and safe in use.

These and other objectives will become apparent from the following description of the invention.

### BRIEF SUMMARY OF THE INVENTION

The improved wheelchair handles of the present invention are intended for use on actuation levers of a standard or custom fitted wheelchair. One set of handles is intended for use on the wheelchair brake lever, while another set of handles is intended for use on the legrest release levers. Each of the handles has a first end with a slot for receiving the planer end of the lever, and a second end extending angularly from the first end so as to be non-planer with the lever. The second end of the handle is non-axial from the longitudinal axis of the levers. The first and second ends are disposed in offset planes from one another. The handles include ribs for tactile enhancement and are made of bright colors for visual enhancement.

### BRIEF DESCRIPTION OF THE DRAWINGS

FIG. 1 is a perspective view of a wheelchair having the improved lever handles of the present invention.

FIG. 1A is an enlargement of a portion of FIG. 1 showing the brake handle and legrest release handle of the present invention.

FIG. 2 is a side elevation view of the brake lever handle of the present invention.

FIG. 3 is a bottom perspective view of the brake lever handle.

FIG. 4 is a bottom plan view of the brake lever handle.

FIG. 5 is a top plan view of the brake lever handle.

FIGS. 6 and 7 are side elevation views of the brake lever handle from opposite sides.

FIG. 8 is a perspective view of the legrest release lever handle of the present invention.

FIG. 9 is a front elevation view of the legrest release lever handle.

FIG. 10 is a top plan view of the legrest release lever handle.

FIGS. 11 and 12 are plan views from opposite ends of the legrest release lever handle.

FIGS. 13A and 13B are side elevation and perspective views of a spring steel wave spacer for use on a handle according to the present invention.

### DETAILED DESCRIPTION OF THE PREFERRED EMBODIMENT

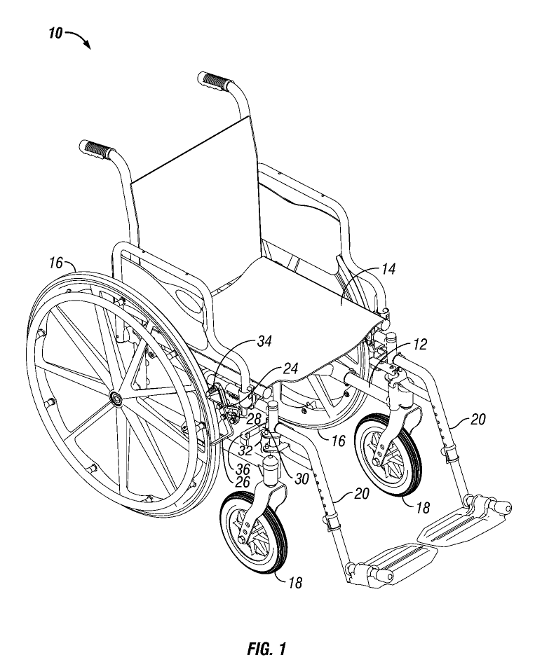

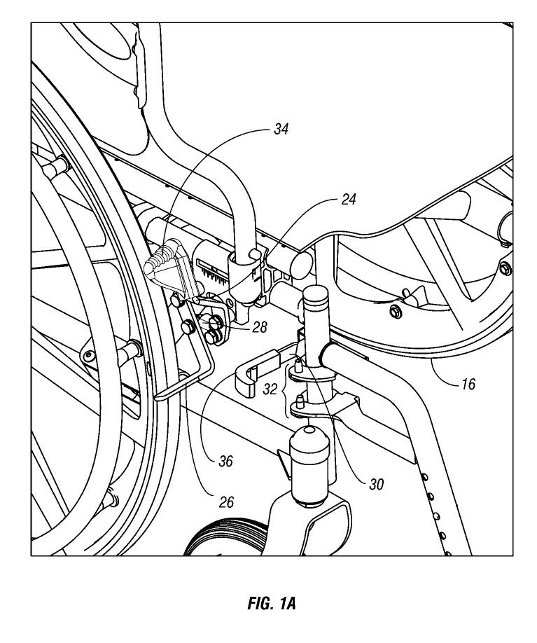

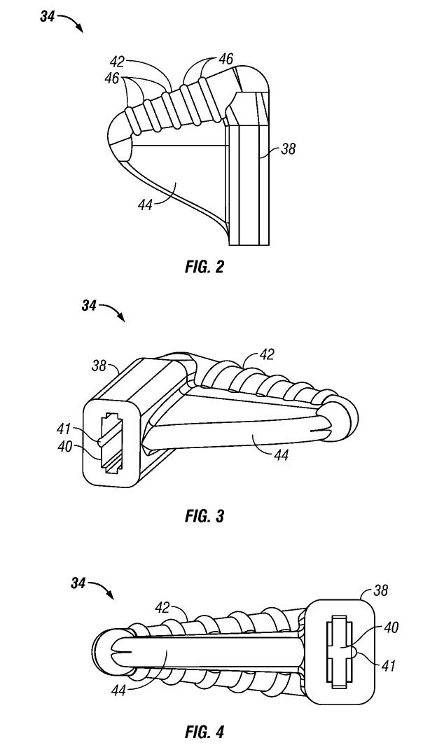

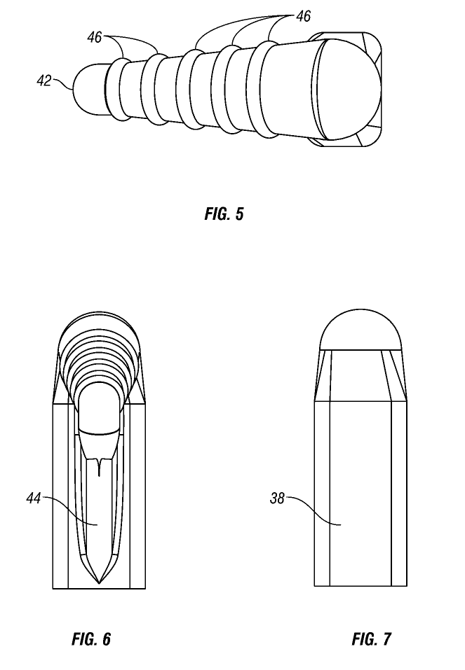

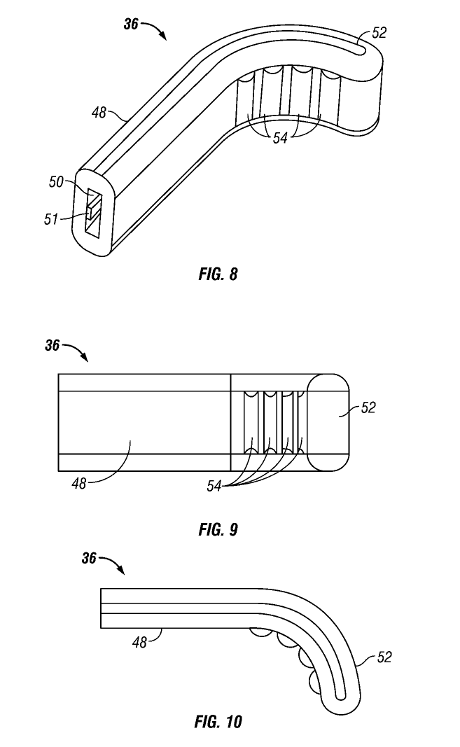

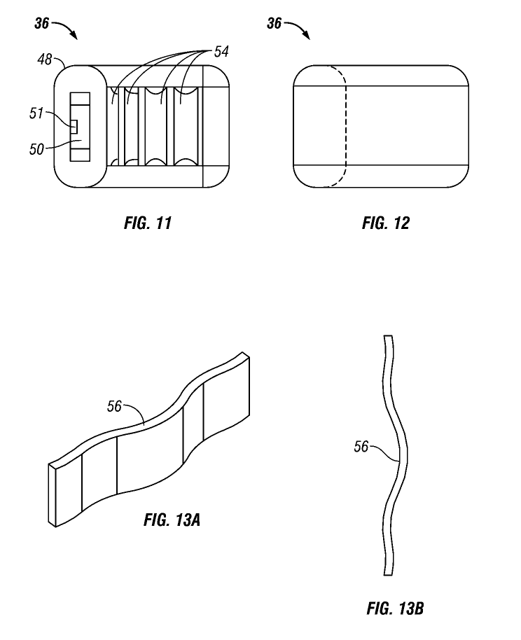

FIG. 1 shows the ergonomically designed handles for a wheelchair, according to the present invention.

More particularly, the wheelchair 10 includes a frame 12, a seat 14, large rear wheels 16, small front wheels 18, and legrest assemblies 20. The wheelchair 10 includes a brake assembly for each of the rear wheels 16. The brake assembly includes a brake lever 24, a brake 26, and linkage 28 connecting the brake lever 24 and the brake 26. The lever 24 is pivotal for movement between a locked position wherein the brake 26 engages the wheel 16, and an unlocked position wherein the brake 26 is disengaged from the wheel 16.

The legrest assemblies 20 are removably mounted on the wheelchair 10. A legrest release lever 30 is pivotal about a vertical axis between locked and unlocked positions. When the legrest lever 30 is in the locked position, the legrest assembly 20 is locked via the hinge pins 32 in a forwardly extending orientation. When the lever 30 is moved to the unlocked position, the legrest assembly 20 is free to rotate outwardly, and if desired, lifted from the hinge pins 32 for removal from the wheelchair 10.

Apart from the handles, described below, the above structure of the wheelchair 10 does not constitute a part of the present invention.

The present invention is directed towards a handle 34 for the brake lever 24, and a handle 36 for the legrest lever 30. Both handles 34 and 36 are ergonomically designed, and have tactile and visual enhancements for easy location by a person sitting in the wheelchair.

More particularly, the brake handle 34 includes a first side or leg 38 with a slot 40 therein for receiving the planer upper end of the brake lever 24. The slot is adapted to frictionally receive the brake lever of various model wheelchairs. For example, a groove 41 may be molded in the slot 40 to receive one or more extrusion members which may compress as the handle 34 is installed on the brake lever 24, thereby providing an enhanced friction fit. The friction prevents the handle 34 from accidentally or easily slipping off of the brake lever 24. The extrusion may be rubber, plastic or other material and compresses, thereby allowing the handle 34 to fit on levers having multiple thicknesses. As a further alternative, a spring steel wave spacer 56 may be inserted into the slot 40. The spacer 56 compresses, thereby allowing the handle 34 to fit onto multiple thickness levers of different wheelchair models and manufacturers. The handle 34 may also be mounted on the brake lever 24 with adhesive. The shape of the slot 40 shown in the drawings will accommodate these mounting alternatives, but it is understood that the slot may have a simple rectangular shape to receive the lever 24, or any other mating shape.

The brake handle 34 has a portion or second leg 42 extending angularly from the first leg 38. As seen in FIG. 2, the angle between the first and second legs 38, 42 is less than 90°, preferably in the range of 45°-80° so as to ergonomically match the natural position of the palm of the hand. The second leg 42 is sufficiently wide to allow use of the palm of the hand to push the brake handle 34 forwardly to actuate or lock the brake 26, and so as to allow multiple fingers to pull the handle 34 so as to unlock or deactuate the brake 26, with the palm of the hand facing substantially downwardly for both pulling and pushing the handle 34.

A web 44 extends between the first leg 38 and the second leg 42 of the brake handle 34 so as to provide structural support to the handle 34. The legs 38, 42 and web 44 define a triangular profile for the handle 34 with an enlarged area for easy visual location of the handle 34. The handle is preferably made of a brightly colored material for enhanced visibility. Also, ribs 46 or other textured surface may be provided on the second leg 42 and/or on the web 44 for improved tactile feel, to facilitate differentiation of the brake handle 34 from other components of the wheelchair 10.

The brake handle 34 is symmetric so that it can be used on the brake levers 24 on both sides of the wheelchair 10.

The legrest release lever handle 36 includes a first leg 48 with a slot 50 adapted to receive the legrest lever 30. The slot 50 of the handle 36 may include internal structure, as described above with respect to the brake handle 34, so as to fit levers having various thickness, such as an interference rib 51, rubber extrusion, and spring steel wave spacer 56. Alternatively, the slot 50 may have a rectangular or complimentary shape for mated mounting on the lever 30.

The legrest handle 36 also includes a second leg 52 extending angularly from the first leg 48 so as to define a curved profile for the handle 36. This ergonomically designed curvature of the handle 36 allows a person to use one or more fingers to easily catch the handle 36 without necessarily looking down for the handle. Preferably, the handle 36 is also made of a brightly colored material so as to allow quick and easy visual identification and location of the handle 36. At least the forwardly facing surface of the handle 36 includes ribs 54 or other textured features, so as to provide an improved tactile feel for the user. Also, preferably the textures of the handles 34 and 36 are similar, so as to provide a common feel for the user in finding both sets of handles. The handle 36 is symmetric so as to be used on the legrest release levers 30 on both sides of the wheelchair 10.

The invention has been shown and described above with the preferred embodiments, and it is understood that many modifications, substitutions, and additions may be made which are within the intended spirit and scope of the invention. For example, it is understood that the ribs 46, 54 may be chanted to any other tactile surface, such as bumps, recesses, knurled surfaces, dimples, and the like. Also, the overall shapes of the handles 34, 36 may be modified, enlarged, curved or otherwise changed for improved visibility and feel. From the foregoing, it can be seen that the present invention accomplishes at least all of its stated objectives.

What is claimed is:

1. An improved handle for actuating a lever on a wheelchair, the lever having a planar end, the handle comprising:
a first end having a slot for receiving the end of the lever;
a second end extending angularly from the first end so as to be non-planar with the lever.

2. The improved handle of claim 1 wherein the first and second ends are disposed in offset planes.

3. The improved handle of claim 1 wherein the handle is a wheelchair brake lever handle.

4. The improved handle of claim 1 wherein the handle is a legrest release lever handle.

5. The improved handle of claim 1 wherein the second end includes a textured surface for tactile enhancement.

6. The improved handle of claim 1 further comprising a web extending between the first and second ends.

7. The improved handle of claim 1 further comprising a curved radius extending between the first and second ends.

8. The improved handle of claim 1 wherein the handle has a triangular profile.

9. The improved handle of claim 1 wherein the handle has a curved profile.

10. The improved handle of claim 1 wherein the handle is brightly colored for visual enhancement.

11. The improved handle of claim 1 further comprising a friction fit member in the slot to accommodate different sized levers on different wheelchairs.

12. An improved wheelchair, comprising:
a lever pivotal about an axis between a locked and unlocked position;
the lever having a longitudinal axis;
a handle mounted on the lever for gripping by a person to move the lever between positions;
the handle having a portion extending non-axially from the lever axis.

13. The improved wheelchair of claim 12 wherein the lever is linked to a wheel brake.

14. The improved wheelchair of claim 12 wherein the lever is linked to a legrest release.

15. The improved wheelchair of claim 12 wherein the handle has a body with a slot for receiving the lever.

16. The improved wheelchair of claim 15 wherein the handle has an extension extending from the body away from the lever.

17. The improved wheelchair of claim 16 wherein the body and extension are angularly oriented with respect to one another.

18. The improved wheelchair of claim 16 wherein the extension includes ribbing for improved tactile identification.

19. The improved wheelchair of claim 16 wherein the extension includes dimples for improved tactile identification.

20. The improved wheelchair of claim 16 wherein the extension includes an orange peel texture for improved tactile identification.

21. The improved wheelchair of claim 12 wherein the handle is brightly colored for enhanced visibility.

22. The improved wheelchair of claim 12 wherein the handle has a triangular profile.

23. The improved wheelchair of claim 12 wherein the handle has a curved profile.

24. The improved wheelchair of claim 12 wherein the handle includes a slot with a friction member therein to provide a friction fit with the lever.
